(19) United States
(12) Patent Application Publication
(10) Pub. No.: US 2021/0347308 A1
(43) Pub. Date: Nov. 11, 2021

(54) MODULAR VEHICLE INTEGRATED CARRIER RACK AND STORAGE SYSTEM WITH UNIVERSAL CONNECTIONS, EXTRUDED AND 3D PRINTED PARTS AND DIGITAL SCREENS

(71) Applicant: Mark A. Anton, Newport Beach, CA (US)

(72) Inventor: Mark A. Anton, Newport Beach, CA (US)

(21) Appl. No.: 17/202,307

(22) Filed: Mar. 15, 2021

Related U.S. Application Data
(60) Provisional application No. 62/989,533, filed on Mar. 13, 2020.

(51) Int. Cl. B60R 9/06; B60L 53/30; B60L 53/66

(52) U.S. Cl. CPC B60R 9/06; B60L 53/66; B60L 53/30

(57) ABSTRACT

Provided are embodiments of systems, devices and methods for lightweight, modular carrier rack and storage systems for vehicles, for example, carrier rack systems that may be integrated into or may be attached to a vehicle. The system may include a carrier bar and a universal mount coupled to the carrier bar. The universal mount may provide charging contacts, and one or more data transfer points.

### CROSS-REFERENCE TO RELATED APPLICATIONS

The present application claims priority to U.S. Provisional Patent Application No. 62/989,533, filed Mar. 13, 2020, the disclosure of which is hereby incorporated by reference in its entirety for all purposes.

The present application is related to European Patent No. 2,969,656, the entire contents and disclosures of which are incorporated herein by reference in their entirety.

The present application is related to U.S. Non-Provisional application Ser. No. 15/054,001 filed Feb. 25, 2016 now U.S. Pat. No. 10,077,005, U.S. Provisional Application No. 62/276,144 filed Jan. 7, 2016, U.S. Provisional Application No. 62/163,638 filed May 19, 2015, and U.S. Provisional Application No. 62/120,825 filed Feb. 25, 2015, the entire contents and disclosures of which are hereby incorporated by reference in their entireties.

The present application is also related to U.S. Non-Provisional application Ser. No. 15/045,142 filed February 16, 2016, now U.S. Pat. No. 9,713,989.

The present application is also related to U.S. Non-Provisional application Ser. No. 14/214,407 filed Mar. 14, 2014 now U.S. Pat. No. 9,290,132, U.S. Provisional Application No. 61/803,101 filed Mar. 18, 2013 and U.S. Provisional Application No. 61/801,951 filed Mar. 15, 2013, the entire contents and disclosures of all of which are hereby incorporated by reference in their entireties.

The present application is also related to U.S. Pat. No. 6,752,302, issued Jun. 22, 2004, the entire contents and disclosures of which are hereby incorporated by reference in its entirety.

The present application is also related to U.S. Non-Provisional application Ser. No. 15/617,770 (now abandoned), U.S. Non-Provisional application Ser. No. 15/045,142 filed Feb. 16, 2016, U.S. Non-Provisional application Ser. No. 14/214,407 filed Mar. 14, 2014, U.S. Provisional Application No. 61/803,101 filed Mar. 18, 2013, U.S. Provisional Application No. 61/801,951 filed Mar. 15, 2013, the entire contents and disclosures of all of which are hereby incorporated by reference in their entireties.

U.S. Non-Provisional application Ser. No. 16/412,311 filed May 14, 2019, the entire contents and disclosures of all of which are hereby incorporated by reference in their entireties.

The present application is also related to U.S. Non-Provisional application Ser. No. 15/873,563 (now abandoned), U.S. Non-Provisional application Ser. No. 16/440,898 filed Jun. 13, 2019, the entire contents and disclosures of all of which are hereby incorporated by reference in their entireties.

The present application is also related to U.S. Non-Provisional application Ser. No. 15/999,366 (now abandoned), U.S. Non-Provisional application Ser. No. 16/120,051 (now abandoned), U.S. Non-Provisional application Ser. No. 16/579,689 filed Sep. 23, 2019, the entire contents and disclosures of all of which are hereby incorporated by reference in their entireties.

The present application is also related to U.S. Non-Provisional application Ser. No. 15/711,720, filed Sep. 21, 2017 (now abandoned), U.S. Non-Provisional application Ser. No. 16/676,362 filed Nov. 6, 2019, U.S. Provisional Application No. 62/554,767 filed Sep. 6, 2017, U.S. Provisional Application No. 62/545,409 filed Aug. 14, 2017, U.S. Provisional Application No. 62/462,285 filed Feb. 22, 2017, U.S. Provisional Application No. 62/431,792 filed Dec. 8, 2016, U.S. Provisional Application No. 62/397,896 filed Sep. 21, 2016, the entire contents and disclosures of which are hereby incorporated by reference in their entireties.

The present application is also related to U.S. Non-Provisional application Ser. No. 16/430,297 filed June 3, 2019, U.S. Provisional Application No. 62/732,520 filed Sep. 17, 2018, U.S. Provisional Application No. 62/681,034 filed Jun. 5, 2018, the entire contents and disclosures of which are hereby incorporated by reference in their entireties.

### FIELD

The present disclosure relates generally to lightweight, modular carrier rack and storage systems for vehicles, and more particularly to carrier rack systems that are integrated into a vehicle or can be attached to a vehicle to carry and store items such as bicycles, skis, snowboards, surfboards, wave boards, wheelchairs, scooters, luggage, fishing gear, accessories, and others.

### BACKGROUND

Present carrier rack systems for vehicles, such as cars, trucks, vans, minivans, sports utility vehicles (SUV's), and motor homes, generally involve a system of multiple straps attached onto the vehicle, a system attached to a universal tow hitch, a system attached to a roof, or a system attached to a bumper. These systems are cumbersome, heavy, and difficult to store at home or in the vehicle when the systems are not in use. Additionally, these systems may not be adaptable to all types of cargo, and when some of these systems are attached, they often make it difficult to see through the glass roof or sunroof. These systems are susceptible to theft and may scratch and damage the vehicle when attached and used. None of the current cargo carrier (transport and storage) systems also provide for the electrical charging of and data transfer to and from the cargo.

In the case of systems involving multiple straps, these systems are complicated to attach onto the vehicle and may loosen with use over time. In the case of systems attached to the roof, these systems create wind resistance when the car is moving and are difficult to access. For carrier systems that are attached to bumpers, these systems damage the sensitive bumper mechanism, have limited supportability and adds excessive weight. For trailer hitch systems, the systems are heavy and difficult to attach, detach, and store.

Additionally, organization and storage space are important for people from all walks of life. Improved organization and storage save time when preparing for activities. It saves space in a home garage, basement, storage garage or shed, closet, office, home, room or any other place things are stored. It may also help prevent injuries that can occur from tripping, falling, dropping, knocking over unstable items, or other accidental or unintentional actions. Likewise, it may save money because when items fall, they may be individually harmed in the form of dents, breaks, chips or other damage or may dent, break, chip, or damage items which they collide with such as motor vehicles.

Accordingly, there is a need for an interface between a vehicle and a cargo that improves organization and storage that allows for simple and easy vehicular transport and storage of multiple types of cargos.

### SUMMARY

The present disclosure relates generally to lightweight, modular carrier rack and storage systems for vehicles, for example, carrier rack systems that may be integrated into a vehicle or may be attached via a tow hitch, attachable trunk or roof rack, carrier rack and storage systems that may be designed through unique, universal connections to carry and store items such as bicycles, skis, snowboards, surfboards, wave boards, wheelchairs, scooters, luggage, fishing gear, accessories, and others.

In some embodiments, the present disclosure may include an interface between a vehicle and a cargo that may improve organization and storage. It may include or may be a modular platform whose universal designs and connections involving the center of gravity of cargo may allow simple and easy vehicular transport and storage of multiple types of recreational or utility equipment and activity pods. It may greatly assist electric vehicles in minimizing the weight of the vehicle while greatly increasing the mechanical, electrical and data functionality of the vehicles.

In some embodiments, the carrier rack and storage systems of the present disclosure may be integrated into vehicles at the time of vehicle manufacture or after production (retrofitting) and they may also attach to other current tow, trunk or roof racks.

In some embodiments, the present disclosure may include a trapezoidal universal mount comprising: a positive contact located at a first angulated side; a negative contact located at a second angulated side; one or more data transfer points located at a bottom side; and wherein the positive contact and the negative contact provide charging contacts, and the one or more data transfer points provide data transfer.

In some embodiments, the present disclosure may include a carrier rack and storage system comprising: a carrier bar; a universal mount coupled to the carrier bar, the universal mount comprises: a positive contact, a negative contact, one or more data transfer points, and wherein the positive contact and the negative contact provide charging contacts, and the one or more data transfer points provide data transfer; and wherein the universal mount provides data transfer to and from a cargo.

This summary and the following detailed description are merely exemplary, illustrative, and explanatory, and are not intended to limit, but to provide further explanation of the invention as claimed. Additional features and advantages of the invention will be set forth in the descriptions that follow, and in part will be apparent from the description, or may be learned by practice of the invention. The objectives and other advantages of the invention will be realized and attained by the structure particularly pointed out in the written description, claims and the appended drawings.

### BRIEF DESCRIPTION OF THE DRAWINGS

The present invention may be better understood by referring to the following figures. The components in the figures are not necessarily to scale. Emphasis instead being placed upon illustrating the principles of the disclosure. In the figures, reference numerals designate corresponding parts throughout the different views.

FIG. 1 illustrates an exemplary sectional view of an improved universal mount. according to some embodiments of the present disclosure

FIG. 2 illustrates an exemplary universal transport and storage system on a scooter, according to some embodiments of the present disclosure.

FIG. 3 illustrates a top view of an exemplary carrier bar, according to some embodiments of the present disclosure.

FIG. 4 illustrates a rear view of a vehicle with a carrier bar, according to some embodiments of the present disclosure.

FIG. 5 illustrates a side view of a vehicle with a carrier bar, according to some embodiments of the present disclosure.

FIG. 6 illustrates an exemplary cross-sectional view of a carrier bar, according to some embodiments of the present disclosure.

FIG. 7 illustrates an exemplary receiver unit, according to some embodiments of the present disclosure.

FIG. 8 illustrates an exemplary adapter bar, according to some embodiments of the present disclosure.

FIG. 9 illustrates an exemplary electrified integrated carrier system, according to some embodiments of the present disclosure.

### DETAILED DESCRIPTIONS

The following disclosure describes various embodiments of the present invention and method of use in at least one of its preferred, best mode embodiments, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

Provided herein are example embodiments of lightweight, modular carrier rack and storage systems for vehicles, for example, carrier rack systems that may be integrated into a vehicle or may be attached via a tow hitch, attachable trunk or roof rack, carrier rack and storage systems that may be designed through unique, universal connections to carry and store items such as bicycles, skis, snowboards, surfboards, wave boards, wheelchairs, scooters, luggage, fishing gear, accessories, and others.

In some embodiments, the carrier rack and storage systems of the present disclosure may include various aspects of modular motor vehicle integrated carrier rack and storage system with universal connections and improvements for the related patents and patent applications as incorporated herein, as mentioned above.

In some embodiments, the carrier rack and storage systems of the present disclosure may include or may be a modular platform whose universal designs and connections involving the center of gravity of cargo may allow simple and easy vehicular transport and storage of multiple types of recreational or utility equipment and activity pods. It may greatly assist electric vehicles in minimizing the weight of the vehicle while greatly increasing the mechanical, electrical and data functionality of the vehicles.

In some embodiments, the carrier rack and storage systems of the present disclosure may be integrated into vehicles at the time of vehicle manufacture or after production (retrofitting) and they may also attach to other current tow, trunk or roof racks.

In some embodiments, the carrier rack and storage systems of the present disclosure may include an interface between a vehicle and a cargo that may improve organization and storage.

In various embodiments described herein, male or female or combination coupling mechanisms may be attached, coupled, or otherwise bonded to currently existing or later developed standard manufacturer or aftermarket crossbars that are located on the roof, side, rear, hood, grill, pickup truck bed, or other locations on vehicles. In some embodiments, these male and/or female coupling mechanisms may have a trapezoidal shaped cross-section. In use, various types of cargo, containers, bags, and other items with one or more male, female or both types of coupling mechanisms can be coupled with complementary shaped coupling mechanisms that are mounted on a vehicle, in order to safely and securely transport the items. As an example, a surfboard with a coupling mechanism, also referred to herein as adaptor, can be attached by clipping, coupling, joining, or otherwise connecting with its complementary shaped mechanism.

In some embodiments, a single cargo carrier bar may be inserted horizontally or at an upward or downward angle into a receiver located, for example, in or on a trunk lid, spare wheel, backdoor, back hatch, or other location of a vehicle.

In some embodiments, universal mounts may be included between the cargo carrier bars and the cargo itself, both in transport and storage (private or public).

Some various devices disclosed above and herein may be described in further detail in one or more related references incorporated herein and as mentioned above.

As disclosed in one or more related references incorporated herein, in some embodiments, the universal mount may include or may be a trapezoidal shaped mount. The universal mounts may provide or receive power, for example, as described in FIGS. 29A and 29B of U.S. Non-Provisional application Ser. No. 16/676,362.

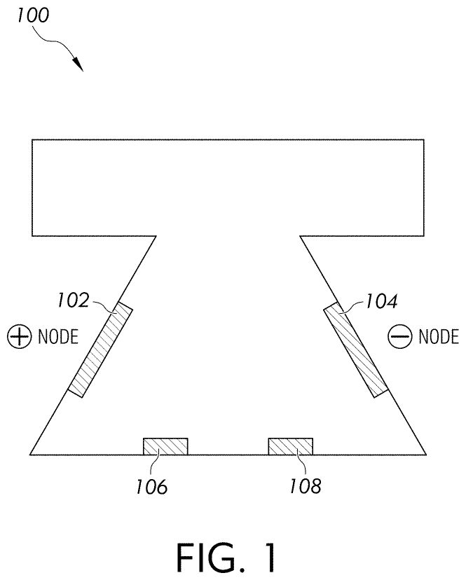

In some embodiments, the universal mounts may include charging of the cargo or data transfer to and from the vehicle. FIG. 1 illustrates an exemplary sectional view of an improved universal mount 100 of the previously described trapezoidal configuration. In some embodiments, in this configuration, the universal mount 100 may include a positive contact 102 and a negative contact 104. The positive and negative contacts may be on the angulated sides of the trapezoid while the data transfer points (e.g., 106 and 108) may be at the bottom of the trapezoidal mount. These positions of charging contacts versus data transfer may also be reversed or placed on similar surfaces.

In some embodiments, the universal mount and connections may utilize a ‘charging gate’ such that the direction of current flow may be detected so that the male mount and corresponding female receiver may be slid into each other from either direction and the electronics may automatically detect and change polarity as needed for proper charging.

In some embodiments, indicators (electric or mechanical) may also be placed on cargo or cargo connections to show the user that the cargo in transport or storage is being charged. There may also be sensors in the vehicle for the driver or rider to know that the universal bar locking mechanisms to connect and lock the cargo to the vehicle are actually engaged and working.

An exemplary cargo may include a food cooler or warming oven with electrical inputs from the vehicle (or storage wall) through the connections, mounts and any adaptors so that food delivery services via electric vehicles of any size can have a container precooled or prewarmed when stored and maintain those temperatures during transit to the delivery locations.

In some embodiments, ancillary electronic devices, e.g., on bikes or other cargo, may be charged through the universal mechanical, electrical and data transfer system, thus allowing these devices to be connected and charged during transport or storage. These devices may include but are not limited to, phones, speakers, computers, helmets, lights, smart satchels, etc.

In some embodiments, the connections may also allow solar panels to recharge the bike or other cargo and therefore also recharge any ancillary electronic devices attached to the bike or cargo.

The present disclosure may also include other similar mechanical mounts on the bike with charging and data transfer capabilities to which ancillary devices and solar panels may be attached.

In some embodiments, helmets may be made with similar or other mechanical attachments to bikes, scooters, etc. that also have charging and data transfer capabilities. This may, for example, allow the lights on the helmet to always be charged and ready for the next ride. It may also allow the owner of a micromobility vehicle (e.g., private or shared bikes) to know if a helmet is detached from the micromobility vehicle or not. The owner may program the micromobility vehicle to not move unless the helmet is detached from the bike, and for example presumably worn.

In some embodiment, sensors in the helmet (for example, in head gripping band or contact points) may also be placed for the same purpose, e.g., the micromobility e-vehicle would not move unless the helmet is detached from vehicle and/or helmet sensors show that it is being worn. This connection capability with data transfer may also ensure that the helmet is always kept with a particular micromobility vehicle as the vehicle may beep until the helmet is replaced and helmet locking mechanism engages.

In embodiments of shared or rental vehicles, the renter may continue to be charged for use of the vehicle and helmet until the helmet is replaced, which the owner would know via the smart connections.

In some embodiments, similar sensors may also be installed in the micromobility vehicle so that it may beep, and the renter may continue to pay until a geolocator senses that the micromobility e-vehicle is in a proper geolocation, and may also be upright.

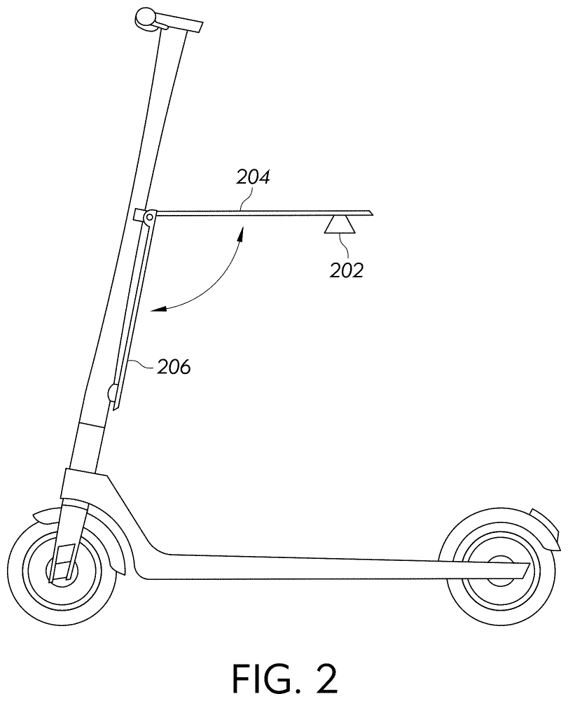

As illustrated in FIG. 2, scooters may also be attached to the universal transport and storage connections through a universal mount placed anywhere near the center of gravity. For example, a mount 202 may be placed near the end of a lever arm 204 that swings out from the vertical handlebar post 206 to a horizontal position. When not in use, the mount 202 may lock back to the vertical handlebar post 206 by a circular latch or strap, or the mount 202 may insert into a locking mechanism in or on the handlebar post 206.

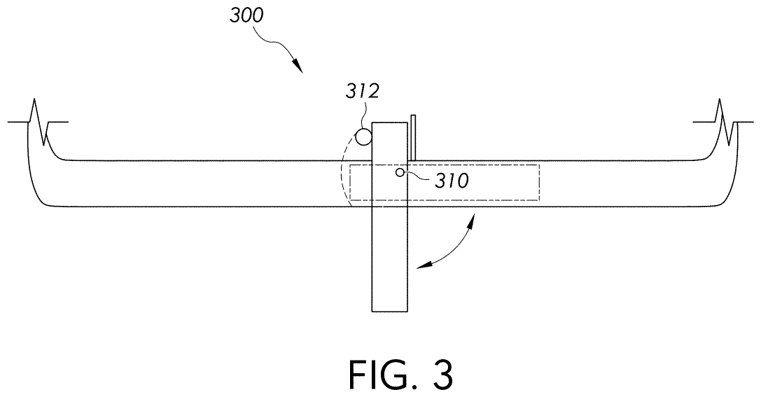

In some embodiments, universal carrier bars may insert into a camouflaged area on the rear end of a vehicle and may be automatically deployed with the push of a button. For example, the bar may recess into the rear deck of a trunk lid and then may deploy by engaging a motor to telescope the bar directly posteriorly in longitudinal direction, parallel to the vehicle. Additional bars may then be manually attached as needed. FIG. 3 illustrates a top view, in some embodiments, of an exemplary bar 300 that may recess into the rear lid of the vehicle (with or without camouflaging coverage) and when a motor is engaged, the bar may rotate ninety degrees in a horizontal or vertical manner and then the end that remains in the trunk lid may lock into position. The horizontal bar may be in a smooth enclosure and may be manufactured with Delrin (or similar) sliding surfaces to facilitate rotation of bar. The bar may have a permanent pivot rod 310 that is fixed to the bar and may be eccentrically placed. A motor may rotate the pivot rod 310 and thus the carrier bar outwardly ninety degrees and the upper and lower surface of the bar and enclosing space may have tight smooth tolerances to allow the rotation of the proximal bar into a receiving slot. Once the proximal end of the carrier bar is in position, the actuator rod 312 engages and locks the bar into place. To disengage the carrier bar, the process may be reversed. Additional bars may then be attached as desired. For example, additional bars may be attached to the carrier bar.

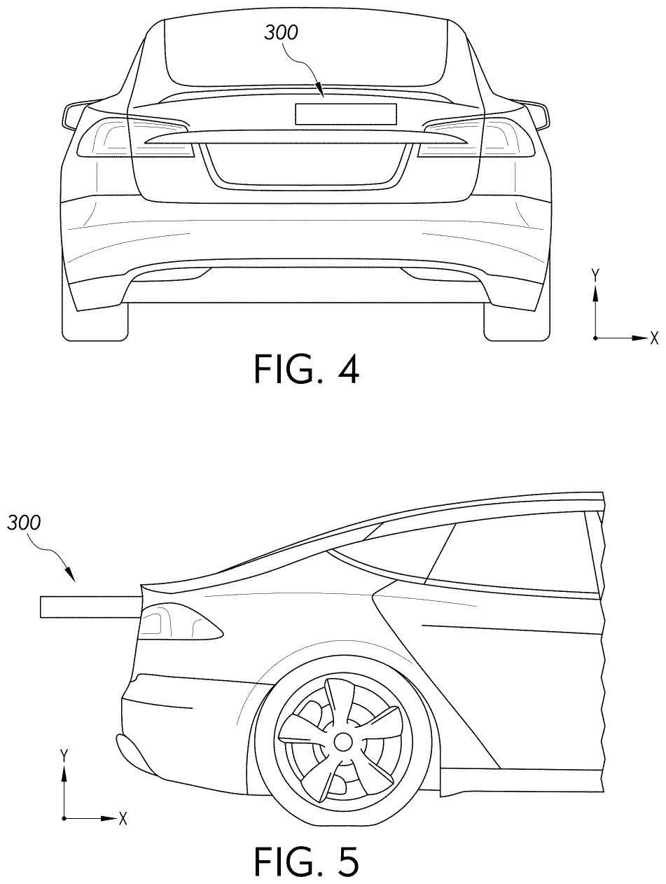

FIG. 4 illustrates an exemplary rear view of a vehicle with the bar 300 of the present disclosure mounted on the back. FIG. 5 illustrates an exemplary side view of a vehicle with the bar 300 of the present disclosure mounted on the back.

In some embodiments, where the bars between the vehicle and the cargo itself are metal, both in transport and storage (private or public), may be uniquely manufactured with extrusion techniques in order to optimize the bar's light weight and strength in all vector planes.

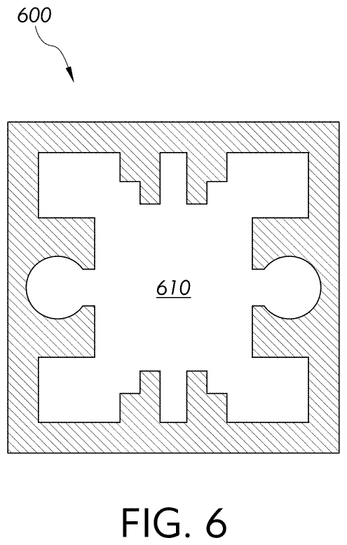

FIG. 6 illustrates an exemplary cross-sectional view of a bar 600, having an internal design 610, according to some embodiments. As illustrated in the example in FIG. 6, in some embodiments, the internal (and external) aspects of the bar may have a large, and may be unlimited, number of extensions with various (e.g., a large, and may be unlimited number of) designs to help strengthen the bar against bending, breaking, flexing, torsion, etc. As shown in the example of FIG. 6, the internal walls of bar have an irregular shape. This methodology may allow a multitude of bar cross-sectional shapes in the strongest and most lightweight manner possible.

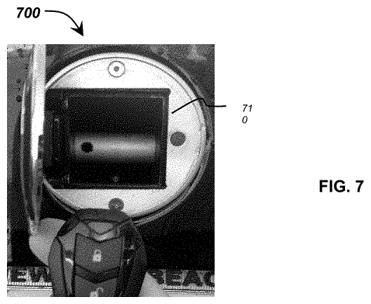

In some embodiments, as described in one or more incorporated references, a receiver unit may be integrated in a vehicle to receive a carrier bar. FIG. 7 shows an exemplary receiver unit 700 in a car. The receiver unit 700 includes a simple rectangular shape tube 710, e.g., to receive a rectangular shape carrier bar. However, as disclosed above, the tube may have any cross-sectional shape, e.g., as shown in FIG. 6, to receive a corresponding carrier bar with similar shape. As such, the cargo carrier bars and the receiver unit(s) (e.g., carrier hitch) in the vehicle or storage location may be similarly manufactured, often with an engaging complementary design.

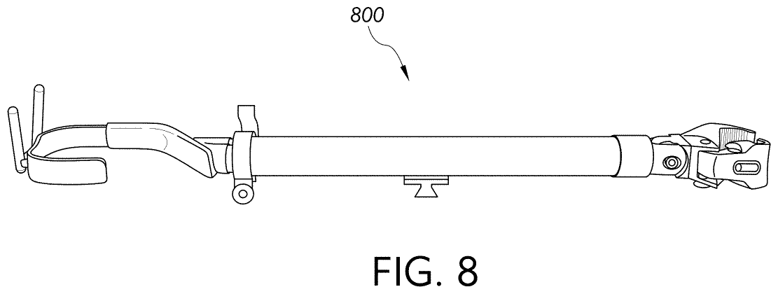

FIG. 8 illustrates an exemplary bar 800 (e.g., bike adaptor bar), as described in one or more incorporated references. The cross-section of the bar 800 is shown as having a round shape with two round parts telescoping into one another. However, extruded telescoping bars of the present disclosure may have any cross-sectional shape, e.g., as shown in FIG. 6. The bike adaptor bar may also be made with extruded metal.

In addition to the use of extruded parts, 3D printed parts (carrier and adaptor bars, trapezoidal mounts, attachment mounts for various bike cargo, etc.) may be made at the factory, dealer, retail store or home and greatly contribute to the universality and utility of the entire vehicular integrated carrier system/platform of the present disclosure.

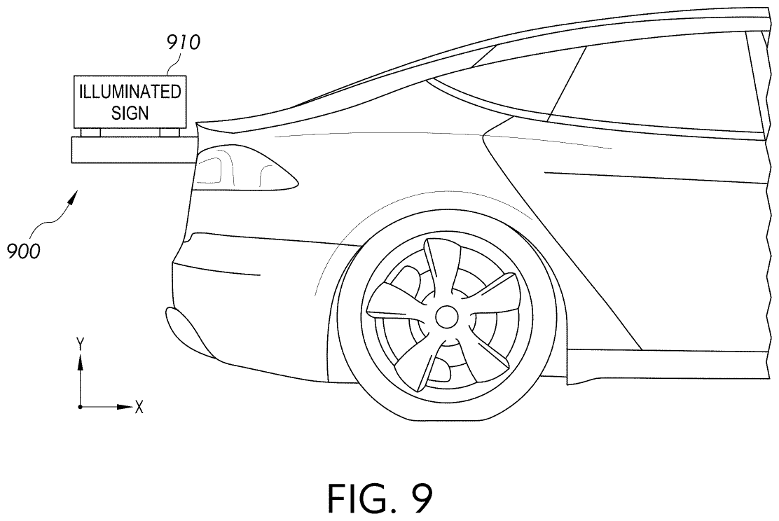

In some embodiments, as illustrated in FIG. 9, an exemplary electrified integrated carrier system 900 of the present disclosure may provide the capability for attaching an object or objects, e.g., illuminated signs/digital screens for streaming content of high resolution as in televisions and computer monitors or lower resolution for advertisement, college banners, etc., to the carrier bar via the trapezoidal mounts (or mounts of other design). In some embodiments, the object may rotate on one of the trapezoidal mounts or be attached on more than one mount for stability and also rotate. The object be made in any dimension, shape or orientation. FIG. 9 illustrates an exemplary rectangular sign that is attached longitudinally relative to the vehicle. In some embodiments, the objects may be attached to the carrier bar along with a warming oven or refrigerated box.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A trapezoidal universal mount comprising:
a positive contact located at a first angulated side;
a negative contact located at a second angulated side;
one or more data transfer points located at a bottom side; and
wherein the positive contact and the negative contact provide charging contacts, and the one or more data transfer points provide data transfer.

2. The trapezoidal universal mount of claim 1 further comprises a charging gate.

3. The trapezoidal universal mount of claim 1, wherein trapezoidal universal mount is integrated into a vehicle carrier bar.

4. A carrier rack and storage system comprising:
a carrier bar;
a universal mount coupled to the carrier bar, the universal mount comprises:
a positive contact,
a negative contact,
one or more data transfer points, and
wherein the positive contact and the negative contact provide charging contacts, and the one or more data transfer points provide data transfer; and
wherein the universal mount provides data transfer to and from a cargo.

5. The carrier rack and storage system of claim 4, wherein the universal mount provides charging to the cargo.

6. The carrier rack and storage system of claim 4, wherein the carrier bar is integrated into the rear of a vehicle.

7. The carrier rack and storage system of claim 4, wherein the carrier bar includes a pivot rod and a receiving rod.

8. The carrier rack and storage system of claim 7, wherein the carrier bar includes a motor that rotates the pivot rod and thus the carrier bar outwardly.

9. The carrier rack and storage system of claim 4, wherein the universal mount has a trapezoidal shape.

10. The carrier rack and storage system of claim 9, wherein the positive contact is located at a first angulated side of the trapezoidal shape; the negative contact is located at a second angulated side of the trapezoidal shape, and one or more data transfer points is located at a bottom side of the trapezoidal shape.

11. The carrier rack and storage system of claim 4, wherein one or more internal walls of the carrier bar has an irregular shape.

12. The carrier rack and storage system of claim 4, wherein the carrier bar receives one or more object via the universal mount.

13. The carrier rack and storage system of claim 12, wherein the one or more object rotates.

14. The carrier rack and storage system of claim 12, wherein the one or more object receives electricity via the universal mount.

15. The carrier rack and storage system of claim 12, wherein the one or more object receives data via the universal mount.
